(19) United States
(12) Patent Application Publication
(10) Pub. No.: US 2007/0050410 A1
(43) Pub. Date: Mar. 1, 2007

(54) Image processing apparatus, image processing method and storage medium storing image processing program

(75) Inventor: Hiroyuki Sayuda, Nakai-machi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/319,950

(22) Filed: Dec. 29, 2005

(30) Foreign Application Priority Data
Aug. 25, 2005 (JP) 2005-243894

(51) Int. Cl. G06F 17/00

(52) U.S. Cl. 707/104.1

(57) ABSTRACT

An image processing apparatus includes an information embedding unit that, upon print output of a document image including link information for access to associated information, embeds identifier information uniquely corresponding to the link information in the document image; a local ID management unit that holds uniquely-set predetermined identification information; an element ID generation unit that generates individual identification information by the link information; a link ID combining unit that combines the identification information held by the local ID management unit with the identification information generated by the element ID generation unit, as the identifier information embedded by the information embedding unit.

### CROSS-REFERENCE TO RELATED APPLICATION

This application claims priority under 35 USC 119 from Japanese Patent Application No. 2005-243894, the disclosure of which is incorporated by reference herein.

### BACKGROUND

1. Technical Field

The present invention relates to an image processing apparatus, an image processing method and an image processing program used upon, for example, print output of a document image including link information for access to associated information.

2. Related Art

In recent years, as an electronic document handled on a computer, a so-called hyper document is widely used. The hyper document has image elements constituting a document such as text, image(s) and graphic(s), and link(s) to connect content information (associated information) such as document(s), image element(s), sound(s), video image(s) associated to the above image elements. For example, a hyper link can be set in a file in the format of PDF (Portable Document Format) well known as a document format for printing. Upon browsing on a monitor, when an image element constituting the document is pointed with a pointing device called mouse, associated information of the image element can be immediately browsed or reproduced.

Note that in such hyper document, upon simple print output, only visible information is printed of information included in the hyper document. As link information or the like is not directly outputted on paper, its characteristic (property) is lost.

### SUMMARY

According to an aspect of the present invention, there is provided an image processing apparatus including: an information embedding unit that, upon print output of a document image including link information for access to associated information, embeds identifier information uniquely corresponding to the link information in the document image; a local ID management unit that holds uniquely-set predetermined identification information; an element ID generation unit that generates individual identification information by the link information; a link ID combining unit that combines the identification information held by the local ID management unit with the identification information generated by the element ID generation unit, as the identifier information embedded by the information embedding unit.

### BRIEF DESCRIPTION OF THE DRAWINGS

An embodiment of the present invention will be described in detail based on the following figures, wherein:

FIG. 1 is a block diagram showing an example of functional construction of an image processing apparatus according to the present invention;

FIGS. 2A and 2B are explanatory diagrams showing examples of system configurations in which the image processing apparatus according to the present invention is employed;

FIG. 3 illustrates a particular example of a management table in the image processing apparatus according to the present invention;

FIGS. 4A and 4B are particular examples of print outputs of document data after processing by the image processing apparatus according to the present invention;

FIG. 5 is a flowchart (1) showing an example of a procedure of an image processing method according to the present invention;

FIG. 6 is a flowchart (2) showing another example of the procedure of the image processing method according to the present invention;

FIG. 7 is a flowchart (3) showing another example of the procedure of the image processing method according to the present invention; and

FIG. 8 is a flowchart (4) showing another example of the procedure of the image processing method according to the present invention.

### DETAILED DESCRIPTION

Hereinbelow, an image processing apparatus, an image processing method and an image processing program according to an aspect of the present invention will be described in detail in accordance with the accompanying drawings. Note that in an embodiment to be described below, a hyper document described in e.g. HTML is print-outputted, however, the present invention is also applicable to print output of other type of documents than the hyper document.

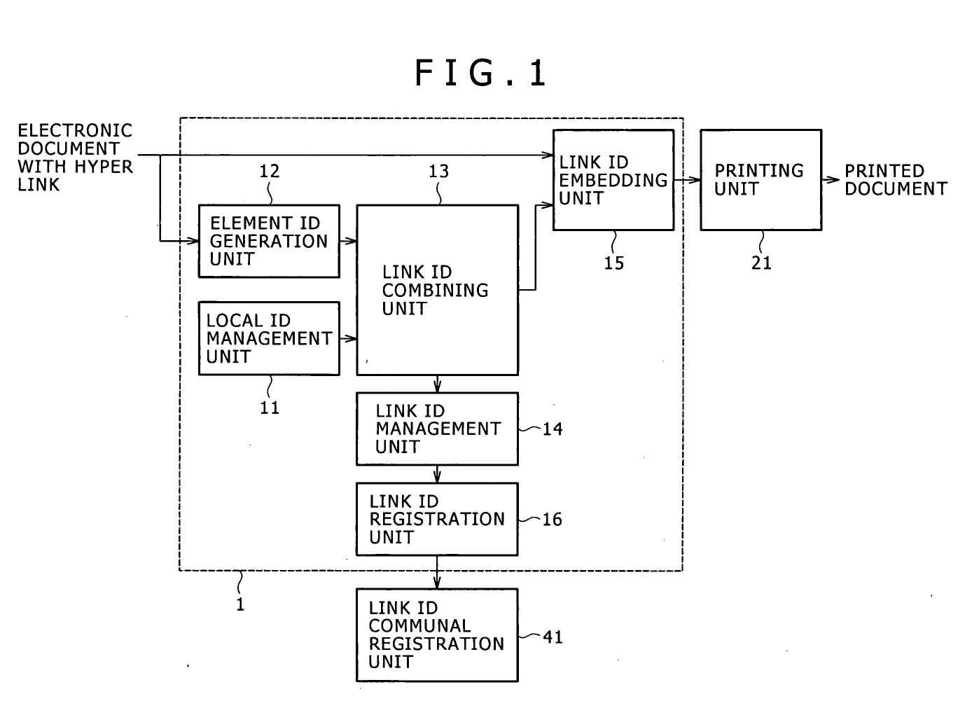

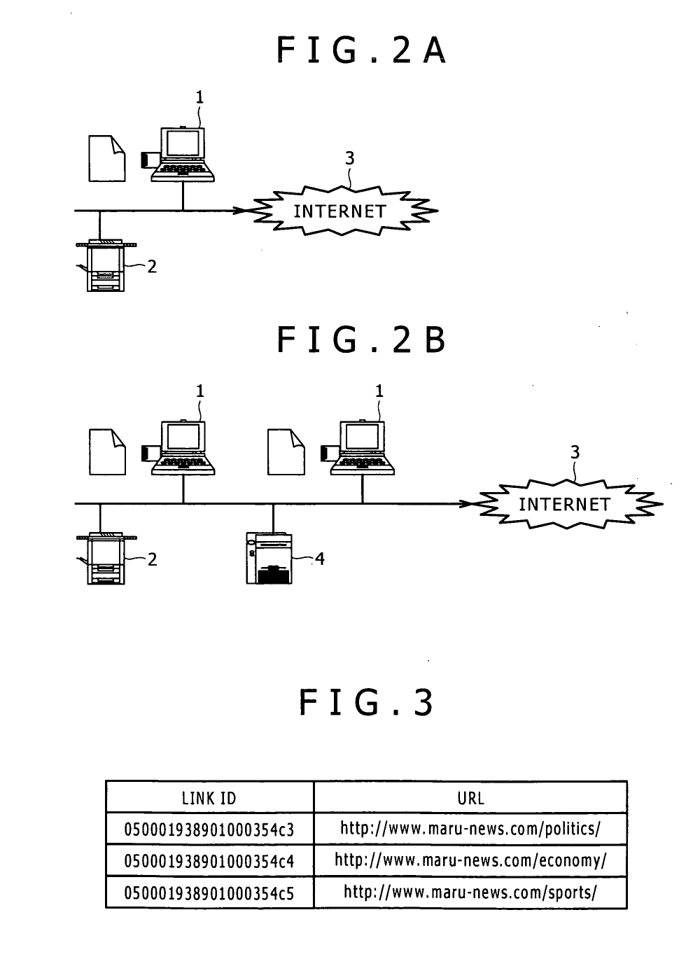

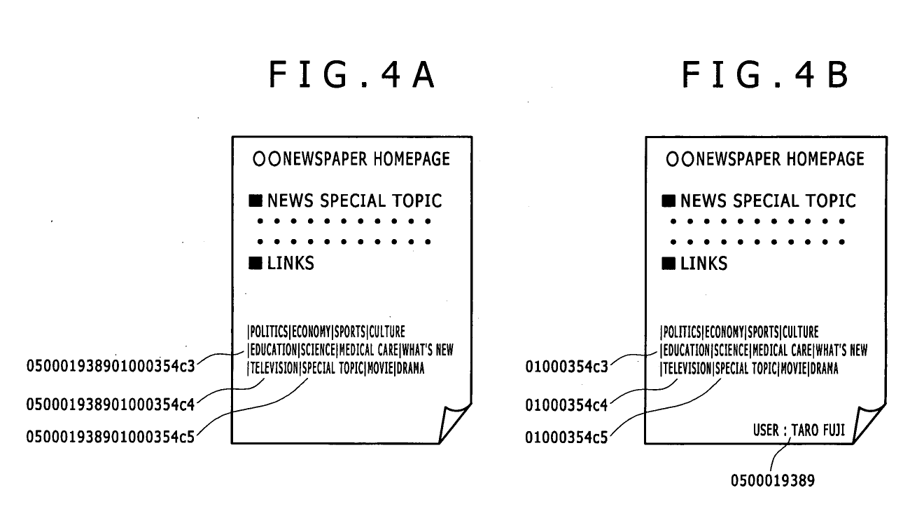

First, a schematic construction of the image processing apparatus will be described. FIG. 1 is a block diagram showing an example of functional construction of the image processing apparatus according to the present invention. FIGS. 2A and 2B are explanatory diagrams showing examples of system configurations in which the image processing apparatus according to the present invention is employed. FIG. 3 illustrates a particular example of a management table in the image processing apparatus according to the present invention. FIGS. 4A and 4B are particular examples of print outputs of document data after processing by the image processing apparatus according to the present invention.

As shown in FIG. 2A, the image processing apparatus to be described here is a personal computer 1 used as a “stand alone” type device (hereinbelow, referred to as a “local PC”), connected with a printer 2 and the Internet 3 for print output of document data. That is, the local PC 1 receives document data described in e.g. HTML, performs necessary processing to print-output the data as a hyper document on a recording medium such as paper, and transmits the document data to the printer 2 to print-output the data. The print output by the printer 2 is performed by utilizing a well-known technique such as electrophotography or ink-jet printing. The print output may be performed by utilizing another image forming apparatus (copier or the like) in place of the printer 2. Further, the input of the document data into the local PC 1 is performed by a user's data input operation at the local PC 1 or by data input via the Internet or the like.

Note that the local PC 1 is available as a “stand alone” device, however, as shown in FIG. 2B, the local PC 1 is applicable to construction of a system including a link ID server 4. That is, the local PC 1 is applicable to construction of a system including plural local PCs 1, the printer 2 and the link ID server 4 respectively connected to the Internet 3.

The document data received and processed by the local PC 1 is data for print output of a hyper document including appearance information and link information.

The appearance information defines drawing positions of image elements constituting the document, such as text(s), image(s) and graphic(s), on the hyper document. The appearance information basically defines the “appearance” of a hyper document, however, some hyper documents include only descriptions of logical meanings of respective image elements such as “paragraph” without clear definition of the “appearance”. Generally, regarding such hyper documents, a browser or the like converts the logical information to appearance information based on predetermined regulations and then performs display or printing. That is, in this case, the appearance of image elements is determined based on the logical information. Accordingly, even document data only having logical information is regarded as data including information defining the appearance.

Further, the link information is information for access to associated information, and used for connection between an image element drawn on a hyper document and associated information of the image element. The “associated information” is content information such as document, image element, sound or video image information associated with the image element constituting the hyper document. For example, when document data is described in HTML, the link information is represented as a URL indicating storage location of associated information. Note that the link information is not limited to the URL but other information to specify a sound file (music file), a video image file, a parameter of application or the like may be used. Further, the application to access associated information and display or reproduce the associated information differs in accordance with link information. For example, a browser handles a URL, but an application to reproduce an MP3 file handles a sound file. Further, an application to start a dictionary tool or the like can be used.

To print-output such document data as a hyper document, the local PC 1 has a local ID management unit 11, an element ID generation unit 12, a link ID combining unit 13, a link ID management unit 14, a link ID embedding unit 15 and a link ID registration unit 16 as shown in FIG. 1.

The local ID management unit 11 holds and manages coded ID (Identification) information as predetermined identification information uniquely set for the local PC 1. Hereinbelow, the code information will be referred to as a “local ID”. As the local ID, when the local PC 1 has software to handle a PDF file, “Acrobat (registered trademark)”, for example, an Acrobat plug-in user ID, an Acrobat serial No. or the like can be used. Note that when the local ID is uniquely set for each local PC 1 or each user to use the local PC 1, other information (e.g., an ID address or a MAC address) may be used. In any case, the local ID may be about 5-byte information. As long as the ID is about 5-byte information, the head 1 byte is allocated to ID type flag and the remaining 4 bytes are used for management of about 4,200,000,000 users.

The element ID generation unit 12 generates coded ID information as individual identification information by link information included in document data to be processed. Hereinbelow, the code information will be referred to as an “element ID”. As the element ID generation unit 12, a binary counter may be employed. Also, the element ID generated by the element ID generation unit 12 may be information of about 5 bytes. As long as the element ID is information of about 5 bytes, the head 1 byte is allocated to an ID type flag and the remaining 4 bytes are used for counting about 4,200,000,000 times.

The link ID combining unit 13 combines the local ID held and managed by the local ID management unit 11 with the element ID generated by the element ID generation unit 12, and obtains coded ID information as the result of combining. Hereinbelow, the code information will be referred to as a “link ID”. The link ID becomes identifier information uniquely corresponding to link information included in document data, and embedded in a document image to be print-outputted as described in detail later.

The link ID management unit 14 manages the linkage between the link ID combined by the link ID combining unit 13 and the link information uniquely corresponding to the link ID. The management of the linkages may be performed by utilizing a well-known technique. More particularly, as shown in FIG. 3, when the link information is a URL, the linkage is managed by using a management table showing linkages between the link IDs and corresponding URLs.

Upon print output of a document image including link information, the link ID embedding unit 15 embeds a link ID uniquely corresponding to the link information in the document image, and transmits the document image after the embedding of the link ID to the printing unit 21 realized with the printer 2, to print-output the document image by the printing unit 21.

Since the link ID is code information, the link ID can be converted to a two-dimensional code for the embedding. As the “two-dimensional code”, a bar code is a representative code, however, other quasi two-dimensional codes may be employed. More particularly, as in the case of “iTone (registered trademark)”, for example, it may be arranged such that the form of pixels (position, shape and the like) constituting a line screen or a dot screen as tonality representation is changed, thereby a two-dimensional code is generated. That is, the two-dimensional code is generated by changing pixel positions, arrangement, geometrical form or a pattern constituted with plural pixels, based on the code value of the link ID. Note that the details of the two-dimensional coding will be omitted since the two-dimensional coding can be performed by utilizing a well-known technique.

Further, the embedding of the link ID can be performed based on the appearance information included in the document data. For example, as shown in FIG. 4A, the link ID is overlaid on the respective image elements of the hyper document, or converted to two-dimensional codes and embedded around the image elements. Further, as shown in FIG. 4B, when the link ID is divided into a “local ID” and an “element ID” and separately embedded, the size of embedded area upon embedding of the information can be reduced. In any case, as the embedded position is specified based on the appearance information by utilizing a well-known technique, the explanation of the specifying will be omitted.

When the local PC 1 has established connection with the link ID server 4, the link ID registration unit 16 registers the link ID, the link information and the linkage between the link ID and the link information managed by the link ID management unit 14, in the link ID server 4. By the registration by the link ID registration unit 16, when a system including the link ID server 4 is constructed, the link ID, the link information and the linkage between the link ID and the link information are communized in the system including the link ID server 4. Note that since the establishment of network connection with the link ID server 4, the information transmission/reception via the network and the like are performed by utilizing well-known techniques, the explanations of the establishment of network connection, the information transmission/reception and the like will be omitted.

The respective units 11 to 16 can be realized with a combination of a CPU (Central Processing Unit) to perform predetermined programs, a ROM (Read Only Memory) to store the predetermined programs and a RAM (Random Access Memory) used as a work area for the CPU, or the like. That is, the respective units 11 to 16 can be realized by execution of the predetermined programs by a function as a computer. Note that in this case, it may be arranged such that the predetermined programs to realize the respective units 11 to 16, which have not been previously installed in the computer, are stored in a computer-readable storage medium, or supplied via cable or radio communication. That is, the image processing apparatus having the above-described construction can be realized with an image processing program to cause the computer to function as the image processing apparatus.

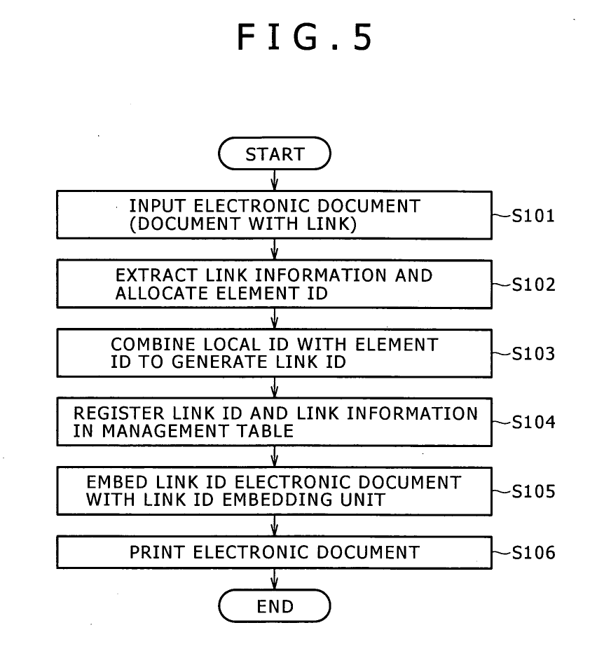

Next, an operation example of processing in the system constructed as above, i.e., an image processing method according to the present embodiment will be described. FIG. 5 to 8 are flowcharts showing examples of procedures of the image processing method.

Upon execution of print output processing of a hyper document, as shown in FIG. 5, the local PC 1 first obtains document data to be print-outputted (step S101; hereinbelow, “step” will be abbreviated to “S”). The document data can be obtained by reception via the Internet 3. Further, the document data may be obtained by data input using document composition software or document management software (hereinbelow, simply referred to as “document software”) operating on the local PC 1.

When the document data has been obtained, next, in the local PC 1, the element ID generating unit 12 extracts link information included in the document data, and generates element IDs for the respective extracted link information and allocates the element IDs to the link information (S102). When the element ID generating unit 12 has generated the element IDs, the link ID combining unit 13 combines the respective element IDs generated by the element ID generating unit 12 with the local ID held and managed by the local ID management unit 11, thereby generates link IDs for the respective link information (S103). Further, the link ID management unit 14 registers the link IDs generated by the link ID combining unit 13 and the link information as basis of the link IDs in a management table, thereby manages the linkage between the respective link IDs and the link information (S104).

Then, the link ID embedding unit 15 performs embedding of the link IDs in the document image (S105). At this time, the link ID embedding unit 15 performs the embedding of the link IDs based on the appearance information included in the document data. That is, to overlay the link IDs on the image elements corresponding to the link IDs (hereinbelow, referred to as “corresponding image elements”) in the document image or to set the link IDs in a portion near the corresponding image elements in the document image, the link ID embedding unit 15 pastes two-dimensional codes (for example, “iTone (registered trademark)”) converted from the link IDs.

More particularly, each of the link IDs to be embedded in the document image is integrally embedded in a corresponding portion (for example, see FIG. 4A). However, a sufficient embedded area cannot be ensured without difficulty in accordance with the size of corresponding image element.

Accordingly, it may be arranged such that, when an link ID is embedded in a document image, the link ID embedding unit 15 performs data amount reduction processing for the link ID or two-dimensional code. The data amount reduction processing may be performed by utilizing a well-known technique, e.g., reduction of the data amount using a hash value obtained with a hash function.

Further, one link ID can be divided into a common part and an individual part instead of being integrally handled. In this case, only the individual part is overlaid on a corresponding image element or embedded in a portion near the corresponding image element, while the common part is embedded in a predetermined portion of the document image (for example, see FIG. 4B). More particularly, in a link ID as a combination of a local ID and an element ID, the local ID is common in the respective link information, and the element ID is individually allocated to each piece of link information. Accordingly, the local ID is embedded in correspondence with an image element, and the element ID is embedded in a predetermined portion such as blank space of the document image (for example, header or footer). In this manner, the size of embedded area upon embedding of link ID can be reduced.

Note that the embedding by the link ID embedding unit 15 is previously set (programmed) in consideration of the number of bytes of local ID and element ID or the like.

When the link ID embedding unit 15 has performed the embedding of the link IDs in the document image, the printing unit 21 performs print output of the image data after the embedding of the link IDs (S106). Since the details of the print output at this time is performed by utilizing a well-known technique, the explanation of the print output will be omitted. Thus, the printing unit 21 print-outputs the document image with which associated information is linked.

In the document image print-outputted as above, the link ID embedded in the document image is obtained by e.g. optical reading, access to the associated information can be performed. That is, the portion where the link ID is embedded is read from the document image, then the result of reading is interpreted, then the result of interpretation is compared with the contents managed by the link ID management unit 14, and link information (URL) corresponding to the link ID can be specified. Accordingly, even when the hyper document is print-outputted, access to associated information can be performed based on the link information.

Next, a procedure upon access from a print-outputted document image to associated information, when a link ID is integrally embedded in a document image, and a procedure upon access from the print-outputted document image to the associated information, when the link ID is divided into a local ID and an element ID and separately embedded in the document image, will be described.

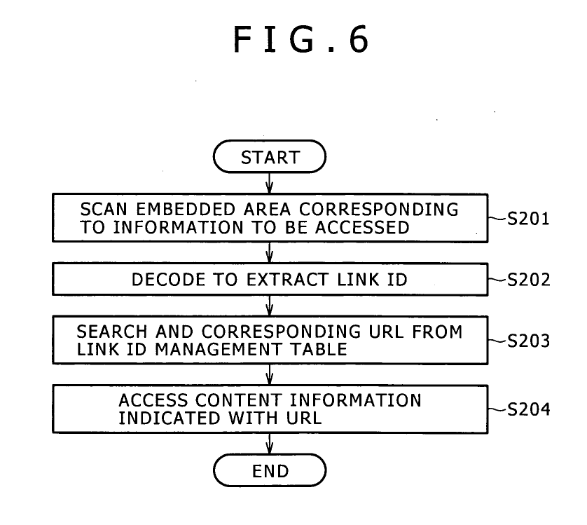

When the link ID is integrally embedded, upon access to the associated information, as shown in FIG. 6, first, an embedded area on the print-outputted document image corresponding to information to be accessed, i.e., a corresponding image element or a near portion is scanned (S201). The scanning at this time is performed by using an image reading device which performs optical image reading utilizing a CCD (Charge Coupled Device) sensor, a CMOS (Complementary Metal Oxide Semiconductor) sensor or the like such as a scanner, a digital camera or a device with a digital camera.

Then, after the scanning, the local PC 1 connected with the image reading device which has performed the scanning obtains the result of scanning from the image reading device, and decodes the obtained result of scanning (image data) to extract the link ID (S202). Then the local PC 1 performs a search for a URL corresponding to the extracted link ID from the management table managed by the link ID management unit 14 and obtains the URL (S203). Thus, it is possible to access associated information (desired content information) from the local PC 1 using a browser or the like based on the URL (S204).

In this manner, when the link ID is integrally embedded, it is possible to access desired content information by one-time scanning.

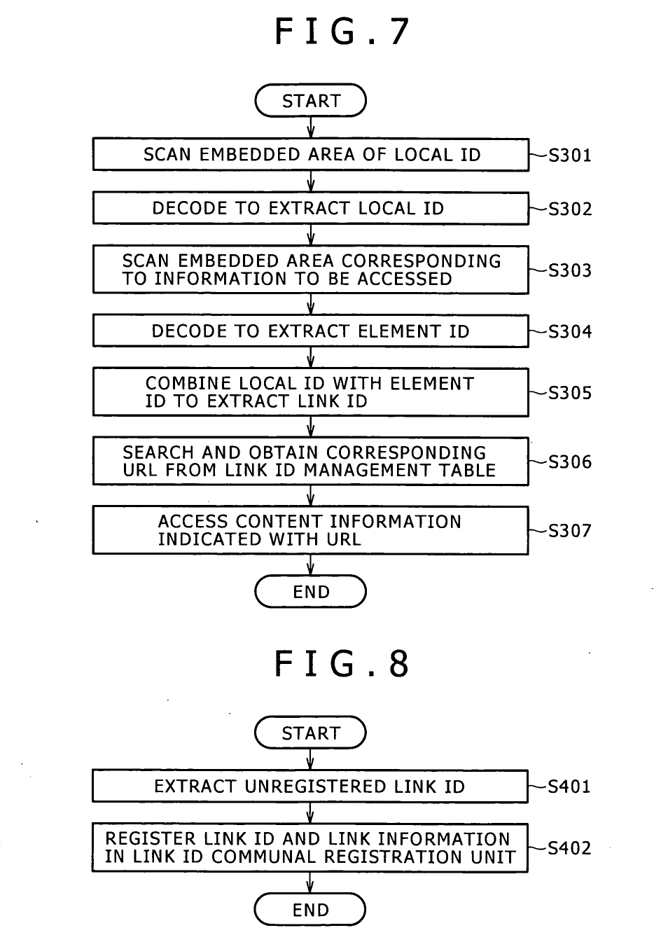

On the other hand, when the link ID is divided into a local ID and an element ID and separately embedded, upon access to associated information, as shown in FIG. 7, first, an embedded area of the local ID on the print-outputted document image, i.e., a predetermined area such as a header or a footer is scanned (S301) . The scanning at this time is performed in a similar manner to that in the above case where the link ID is integrally embedded (see FIG. 5). Then, after the scanning of the embedded area of the local ID, the local PC 1 connected with the image reading device which has performed the scanning obtains the result of scanning from the image reading device, and decodes the obtained result of scanning (image data) and extracts the local ID (S302).

Note that when access to associated information is performed from a document image print-outputted from the printer 2 by the local PC 1 itself, as the local ID can be preset and held upon issuance of a print output instruction to the printer 2, the scanning of the local ID (S301) and the extraction of the local ID (S302) may be omitted on the condition of a user's explicit operation indicating that the local ID is preset and the document image is print-outputted based on the print instruction from the local PC itself.

Thereafter, an embedded area on the print-outputted document image corresponding to information to be accessed, i.e., a corresponding image element as an embedded area of the element ID or a near portion is scanned (S303). Also, the scanning at this time is performed in a similar manner to that in the above case where the link ID is integrally embedded (see FIG. 5). Then, after the scanning of the embedded area of the element ID, the local PC 1 connected with the image reading device which performed the scanning obtains the result of scanning from the image reading device, and decodes the obtained result of scanning (image data) and extracts the element ID (S304).

In this manner, the local ID and the element ID are obtained, and they are combined and a link ID is obtained (S305). Thereafter, as in the case where the link ID is integrally embedded (see FIG. 5), access to associated information can be performed (S306 and S307).

Accordingly, even when a link ID is divided and separately embedded, access to desired content information can be performed. In this case of separate embedding, work for the scanning or presetting is required in comparison with the above-described integral embedding, however, the size of embedded area can be reduced.

As described above, in the local PC 1 described in the present embodiment, i.e., the image processing apparatus, the image processing method and the image processing program according to the present invention, upon print output of a document image, to embed a link ID corresponding to link information in the document image, a uniquely-set local ID is combined with an element ID generated by link information as a link ID embedded in the document image. Even when there are plural devices, programs or users to perform embedding, and further, the document image includes plural pieces of link information, the link ID is the only information. That is, as the link ID is the only information and there is no overlap or the like, in the case of “stand alone” type system, i.e., when the linkage between the identifier information and the link information is locally managed in the local PC 1 and access to associated information is performed based on the locally-managed linkage, access to the associated information can be normally performed.

As described above, according to the image processing apparatus, the image processing method and the image processing program of the present embodiment, even when identifier information embedded in a document image is not.managed by the link ID server 4, as the identifier information is the only information and no overlap or the like occurs, access to associated information can be normally performed even when the local PC 1 is a “stand alone” type device. That is, since it is not necessary to introduce the link ID server 4, an increase in the device cost, the management cost and the like can be suppressed. Further, even in a system without the link ID server 4, or even in an environment where the system is constructed but the local PC 1 cannot access the link ID server 4, access to associated information can be normally performed. Accordingly, the characteristic of a hyper document can be utilized upon print output. Thus, the system offers good convenience to users.

In addition to the use of the local PC 1 described in the present embodiment as a “stand alone” type device, when connection with the link ID server 4 is established and a system including the link ID server 4 has been constructed, the local PC 1 can also be used in the system (for example, see FIG. 2B). It is because, even when plural local PCs 1 exist, since each of link IDs respectively issued from the local PCs 1 is one and only and no overlap or the like occurs, no trouble occurs even when registration in the link ID server 4 is performed for communization in the system after the introduction of the link ID server 4.

Next, a processing procedure in the local PC 1 to establish connection with the link ID server 4 and construct a system including the link ID server 4 will be described.

The local PC 1 establishes connection with the link ID server 4, then, the local PC 1 extracts information which has not been registered in the link ID server 4, from the link IDs, the link information and linkages between the link IDs and the link information managed by the link ID management unit 14 (S401) as shown in FIG. 8. At this time, as registration in the link ID server 4 has not been performed immediately after the establishment of connection with the link ID server 4, all the information managed by the link ID management unit 14 is unregistered. Further, after the execution of the registration in the link ID server 4, when a new link ID is issued in the local PC 1, information on the new link ID becomes unregistered information. Note that the registered/unregistered state of such information is managed by allocation of a flag or the like. Further, it may be arranged such that the user designates unregistered information. That is, it may be arranged such that an unregistered link ID can be selected by the user's operation. In this manner, only the user's desired information is registered, and regarding the other information, communization can be avoided.

When an unregistered link ID and link information corresponding to the unregistered link ID are extracted, the link ID registration unit 16 transmits the extracted link ID and the link information, while keeping the linkage between the extracted link ID and the link information, to the link ID server 4, so as to register them in a link ID communal registration unit 41 (S402). Thus, when a system including the link ID server 4 is constructed, the link ID, the link information and the linkage therebetween are communized in the system including the link ID server 4.

Accordingly, after the communization of the link ID in the system, it is possible to access associated information (desired information) by accessing the link ID server 4 and comparing the result of scanning of the link ID from a document image with the registered contents in the link ID communal registration unit 41. That is, regardless of which local PC 1 is an issuer of a link ID, it is possible to access desired content information from any of the plural local PCs 1 connected with the link ID server 4.

The registration processing for communization of a link ID in the system is performed in the following timing.

For example, when a user of a local PC 1 operates operating devices of the local PC 1 such as a keyboard and a mouse thereby inputs an explicit registration instruction, the link ID registration unit 16 of the local PC 1, upon input of the registration instruction, performs registration of unregistered information from information on the link IDs managed by the link ID management unit 14 of the local PC 1, in the link ID communal registration unit 41. The registration processing, performed at this timing, corresponds to the user's intended registration processing. That is, the user's intention is reflected in the registration processing for link ID communization.

Further, the link ID registration unit 16 may perform the registration processing at predetermined periodical timing. More particularly, it may be arranged such that the registration processing is performed at predetermined time or by predetermined period, managed by utilizing a timer function. In the registration processing at such timing, the registration processing is automatically performed without the user's operation.

Further, the link ID registration unit 16 may perform the registration processing upon establishment of network connection between the local PC 1 and the link ID server 4. The establishment of network connection means establishment of a communicable status between the local PC 1 and the link ID server 4, and more particularly, dial-up connection via a public line network or the like. By the execution of the registration processing at this timing, the registration processing is automatically performed every time network connection has been established between the local PC 1 and the link ID server 4. That is, this arrangement unnecessitates the user's input of an instruction for the registration processing and avoids the execution of the registration processing at the user's unintended periodical timing.

At any timing of the execution of the registration processing, as long as a link ID is communized in the system by the registration processing, it is possible for the local PC 1 in a “stand alone” environment to issue a link ID then introduce the link ID server 4 to perform management of the link IDs in the system. Accordingly, for example, in an environment where the user cannot access the link ID server 4 (e.g., at home), the user can print-output a Web page using a notebook type local PC 1, then connect the local PC 1 with an intranet of the user's company. Then the link ID issued by the local PC 1 can be registered in the link ID server 4 in the intranet. Thus the convenience for users can be greatly improved in comparison with the related art.

As described above, According to an aspect of the present invention, there is provided an image processing apparatus including: an information embedding unit that, upon print output of a document image including link information for access to associated information, embeds identifier information uniquely corresponding to the link information in the document image; a local ID management unit that holds uniquely-set predetermined identification information; an element ID generation unit that generates individual identification information by the link information; a link ID combining unit that combines the identification information held by the local ID management unit with the identification information generated by the element ID generation unit, as the identifier information embedded by the information embedding unit; and a link ID management unit that manages linkage between the identifier information combined by the link ID combining unit and the link information uniquely corresponding to the identifier information.

Further, According to an aspect of the present invention, there is provided an image processing method used upon print output of a document image including link information for access to associated information, including: holding uniquely-set predetermined identification information; generating individual identification information by the link information; combining the identification information held at the local ID management step with the identification information generated at the element ID generation step, as identifier information uniquely corresponding to the link information; embedding the identifier information combined at the link ID combining step in the document image; and managing linkage between the identifier information and the link information.

Further, According to an aspect of the present invention, there is provided a storage medium readable by a computer, the storage medium storing an image processing program of instructions executable by the computer to perform a function for, upon print output of a document image including link information for access to associated information, embedding identifier information uniquely corresponding to the link information in the document image, the function including: holding uniquely-set predetermined identification information; generating individual identification information by the link information; combining the identification information held by the local ID management unit with the identification information generated by the element ID generation unit, as the identifier information embedded by the information embedding unit; and managing linkage between the identifier information combined by the link ID combining unit and the link information uniquely corresponding to the identifier information.

According to the image processing apparatus, the image processing method and the image processing program having the above constructions, upon print output of a document image, when identifier information corresponding to link information is embedded in the document image, uniquely-set predetermined identification information and individual identification information generated by link information are combined and embedded in the document image as identifier information. As the “predetermined identification information”, local ID information uniquely set by device to perform embedding of identifier information, by program, or by user to instruct embedding, can be used. Further, as “individual identification information”, count number information sequentially allotted to each piece of link information in the document image can be used. Accordingly, when these pieces of information are combined as the identifier information, the identifier information becomes the only information even when there are plural devices, programs or users to perform embedding, and further, even when the document image includes plural pieces of link information. That is, as the identifier information is the only information and there is no overlap or the like, in the case of “stand alone” type system, i.e., when the linkage between the identifier information and the link information is locally managed and access to associated information is performed based on the locally-managed linkage, the access to the associated information can be normally performed.

According to the image processing apparatus, the image processing method and the image processing program of the present embodiment, even when identifier information embedded in a document image is not managed by a link ID server, as the identifier information is the only information and no overlap or the like occurs, access to associated information can be normally performed even in a “stand alone” type system. Accordingly, it is not necessary to construct a system including a link ID server to cause an increase in the device cost, the management cost and the like. Further, even in an environment where the link ID server is not accessible, the characteristic of a hyper document can be utilized upon print output. Thus, the system offers good convenience to users.

Note that in the present embodiment, a specific example of the present invention has been described, however, the present invention is not limited to the contents of the embodiment. For example, the data format of (the number of bytes or the like) of the local ID, the element ID and the link ID is not limited to that described in the present embodiment. That is, the present invention can be appropriately changed in a break with the contents described in the present embodiment within the scope of the invention.

What is claimed is:

1. An image processing apparatus comprising:
an information embedding unit that, upon print output of a document image including link information for access to associated information, embeds identifier information uniquely corresponding to the link information in the document image;
a local ID management unit that holds uniquely-set predetermined identification information;
an element ID generation unit that generates individual identification information by the link information;
a link ID combining unit that combines the identification information held by the local ID management unit with the identification information generated by the element ID generation unit, as the identifier information embedded by the information embedding unit.

2. The image processing apparatus according to claim 1, wherein the information embedding unit embeds the identifier information based on appearance information corresponding to the document image.

3. The image processing apparatus according to claim 1, wherein the information embedding unit overlays one piece of identifier information on a corresponding image element in the document image or embeds the one piece of identifier information in a portion near the corresponding image element.

4. The image processing apparatus according to claim 1, wherein the information embedding unit divides the identifier information into a common part and an individual part, overlays only the individual part on a corresponding image element in the document image or embeds only the individual part in a portion near the corresponding image element, and embeds the common part in a predetermined portion in the document image.

5. The image processing apparatus according to claim 1, further comprising a link ID management unit that manages linkage between the identifier information combined by the link ID combining unit and the link information uniquely corresponding to the identifier information.

6. The image processing apparatus according to claim 5, further comprising a link ID registration unit that establishes network connection with a server which manages the identifier information, and registers the identifier information, the link information and the linkage between the identifier information and the link information managed by the link ID management unit in the server, thereby communizes the identifier information, the link information and the linkage in a system including the server.

7. The image processing apparatus according to claim 6, further comprising an operation unit that inputs a registration instruction,
wherein the link ID registration unit performs the registration based on input of the registration instruction with the operation unit.

8. The image processing apparatus according to claim 6, wherein the link ID registration unit performs the registration at predetermined periodical timing.

9. The image processing apparatus according to claim 6, wherein the link ID registration unit performs the registration upon establishment of the network connection with the server.

10. An image processing apparatus for processing data of a document image including link information for access to associated information, the apparatus comprising:
an information embedding unit that embeds first identification information and second identification information, the first information including information corresponding uniquely to the apparatus, the second information corresponding to the link information in the document image.

11. The image processing apparatus according to claim 10, wherein the information embedding unit embeds the first and second information based on appearance information included in the document image.

12. The image processing apparatus according to claim 10, wherein the information embedding unit embeds the first and second information so that at least one of the first and second information is embedded in a portion near a corresponding image element.

13. The image processing apparatus according to claim 10, wherein the information embedding unit embeds the first and second information so that at least one of the first and second information overlaps a corresponding image element in the document image.

14. The image processing apparatus according to claim 10, further comprising a link ID combining unit that combines the first and second information,
wherein the information embedding unit embeds the combined information in the document image.

15. An image processing method used upon print output of a document image including link information for access to associated information, comprising:
holding uniquely-set predetermined identification information;
generating individual identification information;
combining the identification information held at the local ID management step with the identification information generated at the element ID generation step, as the identifier information uniquely corresponding to the link information; and
embedding the identifier information combined at the link ID combining step in the document image.

16. An image processing method according to claim 15, wherein the identifier information is embedded based on appearance information corresponding to the document image.

17. An image processing method according to claim 15, further comprising;
managing linkage between the identifier information and the link information.

18. A storage medium readable by a computer, the storage medium storing a program of instructions executable by the computer to perform a function for image processing, upon print output of a document image including link information for access to associated information, the function comprising:
holding uniquely-set predetermined identification information;
generating individual identification information by the link information;
combining the identification information held by the local ID management unit with the identification information generated by the element ID generation unit, as the identifier information embedded by the information embedding unit; and
embedding identifier information uniquely corresponding to the link information in the document image.

19. A storage medium according to claim 18, wherein the identifier information is embedded based on appearance information corresponding to the document image.

20. A storage medium according to claim 18, the function further comprising;
managing linkage between the identifier information combined by the link ID combining unit and the link information uniquely corresponding to the identifier information.
